(19) United States
(12) Patent Application Publication
(10) Pub. No.: US 2026/0328472 A1
(43) Pub. Date: Oct. 22, 2026

(54) REFRIGERATOR

(71) Applicant: SAMSUNG ELECTRONICS CO., LTD., Suwon-si (KR)

(72) Inventors: Taecheol PARK, Suwon-si (KR); Cheolmin LEE, Suwon-si (KR); Byoungjae CHO, Suwon-si (KR); Seunghyeok SON, Suwon-si (KR); Sehyeon BAEK, Suwon-si (KR); Ilsung BAE, Suwon-si (KR); Changgu KANG, Suwon-si (KR)

(73) Assignee: SAMSUNG ELECTRONICS CO., LTD., Suwon-si (KR)

(21) Appl. No.: 19/669,359

(22) Filed: May 6, 2026

Related U.S. Application Data
(63) Continuation of application No. PCT/KR2026/004429, filed on Mar. 19, 2026.

(30) Foreign Application Priority Data
Apr. 18, 2025 (KR) 10-2025-0051171
Aug. 4, 2025 (KR) 10-2025-0107095

(51) Int. Cl. F25D 23/02; E05F 5/02

(52) U.S. Cl. CPC F25D 23/028; E05F 5/02; E05Y 2201/224; E05Y 2900/31; F25D 2323/023; F25D 2323/024

(57) ABSTRACT

A refrigerator may include: a main body including a storage compartment, and an inner and an outer case; an inner door that is rotatable to open and close the storage compartment, the inner door including an opening; an outer door in front of the inner door and that is rotatable to open and close the opening; a hinge to which the outer door is coupled , and including: a shaft that allows the outer door to rotate, and a rotation limiter on the shaft configured to limit an opening angle of the outer door relative to the inner door; and a stopper on the outer door and configured to: with the outer door rotated relative to the inner door, move along a circumference of the shaft, and with the stopper in contact with the rotation limiter, limit the opening angle of the outer door relative to the inner door.

### CROSS-REFERENCE TO RELATED APPLICATIONS

This is a continuation application, under 35 U.S.C. §111(a), of International Application PCT/KR2026/004429, filed Mar. 19, 2026, which claims priority under 35 U.S.C. §119 to Korean Patent Application No. 10-2025-0051171, filed Apr. 18, 2025 and Korean Patent Application No. 10-2025-0107095, filed Aug. 4, 2025, in the Korean Intellectual Property Office, the disclosures of which are incorporated herein in their entireties by reference.

### TECHNICAL FIELD

The present disclosure relates to a refrigerator including an improved structure.

### Background Art

A refrigerator is a home appliance that includes a main body including a storage compartment, a cold air supply device configured to supply cold air to the storage compartment, and a door configured to open and close the storage compartment to keep food fresh.

The door of the refrigerator may be configured to open and close the storage compartment by rotating around a rotational axis.

The door of the refrigerator may include an inner door including an opening and provided to be rotatably connected to the main body, and an outer door configured to be rotatable relative to the inner door to open and close the opening of the inner door.

### Disclosure

### Technical Problem

The present disclosure is directed to providing a refrigerator capable of limiting an opening angle of an outer door.

Further, the present disclosure is directed to providing a refrigerator including a hinge with which a rotation limiter is integrated.

Further, the present disclosure is directed to providing a refrigerator including a hinge in which a rotation limiter is formed on a shaft.

Additional aspects of the disclosure will be set forth in part in the description which follows and, in part, will be obvious from the description, or may be learned by practice of the disclosure.

### Technical Solution

In accordance with the present disclosure, a refrigerator may include: a main body, in which a storage compartment is formed, the main body including an inner case and an outer case; an inner door that is rotatable relative to the main body to open and close the storage compartment, the inner door including an opening; an outer door in front of the inner door and that is rotatable relative to the inner door to open and close the opening; a hinge to which the outer door is coupled, the hinge including: a shaft that allows the outer door to rotate, and a rotation limiter on the shaft that is configured to limit an opening angle of the outer door relative to the inner door; and a stopper on the outer door and configured to: with the outer door rotated relative to the inner door, move along a circumference of the shaft, and with the stopper in contact with the rotation limiter, limit the opening angle of the outer door relative to the inner door.

The stopper may be coupled to the outer door, with the outer door rotated relative to the inner door, the stopper may move in a angular range along the circumference of the shaft, and at an end position of the angular range, movement of the stopper may be stopped by the rotation limiter such that rotation of the outer door relative to the inner door in an opening direction is stopped.

The shaft may further include: an outer circumferential surface portion including an outer circumferential surface of the shaft extended along a first portion of the shaft and having a first radius that is a constant distance from a center of the shaft, and a rotation guide portion including a rotation guide surface of the shaft extended along a second portion of the shaft and having a second radius that is less than the first radius, the rotation guide portion configured such that, with the outer door rotated relative to the inner door, the rotation guide portion allows the stopper to move along a rotational movement path.

The rotation limiter may extend from an end of the rotation guide portion to and end of the outer circumferential surface portion.

With the stopper spaced apart from the rotation limiter, the stopper may be spaced apart from the rotation guide portion in a radial direction of the shaft.

The stopper may include an end portion on a side facing the shaft, and a distance between the end portion and a center of the shaft may be less than the first radius.

The stopper may include a contact surface that extends from the end portion to an edge of the stopper, and with the stopper in contact with the rotation limiter, the contact surface may be in surface contact with the rotation limiter.

The contact surface may be inclined from the end portion in a direction away from the center of the shaft.

The hinge may be on the inner door and may move together with the inner door, and the stopper may move together with the outer door.

The hinge may further include a plate coupled to the inner door, and the shaft and the plate may be formed integrally with each other.

The shaft may include: a rotation shaft portion inserted into the outer door, and a reinforcing portion between the rotation shaft portion and the plate, and a radius of the shaft along the reinforcing portion may be greater than a radius of the shaft along the rotation shaft portion.

The rotation limiter may include a flat surface that extends on a portion of the rotation shaft portion and on a portion of the reinforcing portion.

the rotation guide portion may include a curved surface that extends on a portion of the rotation shaft portion and on a portion of the reinforcing portion.

With the outer door rotated relative to the inner door to a closed position where the opening is closed by the outer door, the stopper may be above the plate of the hinge.

The rotation limiter may be cut into a cylindrical shaft, or the hinge may be shaped by a die to include the rotation limiter.

Another aspect of the present disclosure provides a refrigerator including: a main body, in which a storage compartment is formed, the main body including an inner case and an outer case; a door configured to open and close the storage compartment and including an inner door including an opening, an outer door configured to open and close the opening, and a hinge configured to allow the inner door and the outer door to rotate relative to each other and including a shaft. The shaft includes a first circumferential surface including a first radius with respect to a circumferential direction, and a second circumferential surface in which a distance from a center of the shaft is different from the first radius and a rotation limiter is provided.

### DESCRIPTION OF DRAWINGS

FIG. 1 is a perspective view of a refrigerator according to one embodiment of the present disclosure.

FIG. 2 is a perspective view illustrating a state in which an outer door of the refrigerator according to one embodiment of the present disclosure is open.

FIG. 3 is a perspective view illustrating a state in which all doors of the refrigerator according to one embodiment of the present disclosure are open.

FIG. 4 is a perspective view illustrating a state in which the outer door is open in the door of the refrigerator according to one embodiment of the present disclosure.

FIG. 5 is an enlarged-perspective view of a region corresponding to a region A of FIG. 4, illustrating a state in which the outer door is separated from an inner door in the door of the refrigerator according to one embodiment of the present disclosure.

FIG. 6 is an enlarged-perspective view of a region corresponding to a region B of FIG. 4, illustrating a state in which the outer door is separated from the inner door in the door of the refrigerator according to one embodiment of the present disclosure.

FIG. 7 is an enlarged-perspective view of a region corresponding to the region B of FIG. 4 when viewed from a different direction, illustrating a state in which the door according to one embodiment of the present disclosure is disassembled into some components.

FIG. 8 is a perspective view of a hinge and a stopper according to one embodiment of the present disclosure.

FIG. 9 is a perspective view of the hinge and the stopper according to one embodiment of the present disclosure.

FIG. 10 is a front view of the hinge and the stopper according to one embodiment of the present disclosure.

FIG. 11 is a top view of the hinge and the stopper according to one embodiment of the present disclosure.

FIG. 12 is a perspective view of a hinge and a stopper according to one embodiment of the present disclosure.

### MODES OF THE INVENTION

The various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of "and / or" includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (importance or order) of elements.

In the following detailed description, the terms of “front surface”, “rear surface”, “upper surface”, “lower surface”, “side surface”, “left side”, “right side”, “upper portion”, “lower portion”, and the like may be defined by the drawings, but the shape and the location of the element is not limited by the term.

In this disclosure, the terms "including", "having", and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

A refrigerator according to one embodiment may include a main body.

The main body may include an insulation. The insulation may insulate an interior and an exterior of a storage compartment to allow a temperature inside the storage compartment to be maintained at a set temperature without being affected by an external environment of the storage compartment. In one embodiment, the insulation may include a foam insulation, such as polyurethane foam. In one embodiment, the insulation may additionally include a vacuum insulation in addition to the foam insulation, or the insulation may be composed of only the vacuum insulation instead of the foam insulation.

The storage compartment may store various items such as food, medicine, and cosmetics, and the storage compartment may be formed to allow at least one side to be open for taking items in and out.

The refrigerator may include one or more storage compartments. When the refrigerator includes two or more storage compartments, each compartment may have a different purpose and be maintained at different temperatures. For this, each storage compartment may be separated from the others by a partition wall containing an insulation.

The storage compartment may be provided to be maintained at an appropriate temperature range depending on the intended use, and may include a "refrigerating compartment," a "freezing compartment," or a "variable temperature compartment" which are distinguished according to the intended use and/or temperature range. The refrigerating compartment may be maintained at a temperature appropriate for refrigerating items, and the freezing compartment may be maintained at a temperature appropriate for freezing items. "Refrigerating" may mean cooling items to a temperature that does not freeze the items, and for example, a refrigerating compartment may be maintained in a range of 0 degrees Celsius to +7 degrees Celsius. "Freezing " may mean cooling items to freeze the items or keep the items in a frozen state, and for example, a freezing compartment may be maintained in a range of -20 degrees Celsius to -1 degree Celsius. The variable temperature compartment may be used as either a refrigerating compartment or a freezing compartment, at the user's choice or not.

The storage compartment may also be called by various other names such as "vegetable compartment," "fresh compartment," "cooling compartment," and "ice-making compartment" in addition to “refrigerating compartment”, “freezing compartment”, and “variable temperature compartment”. The terms “refrigerating compartment”, “freezing compartment”, and “variable temperature compartment” used hereinafter should be understood to encompass storage compartments having corresponding uses and temperature ranges.

According to one embodiment, the refrigerator may include at least one door configured to open and close an open side of a storage compartment. The door may be configured to open and close one or more storage compartments, or a single door may be configured to open and close a plurality of storage compartments. The door may be installed on a front surface of the main body in a rotating or sliding manner.

The door may be configured to seal the storage compartment when the door is closed. The door may include an insulation, similar to the main body, to insulate the storage compartment when the door is closed.

According to one embodiment, the door may include a door outer panel forming a front surface of the door, a door inner panel forming a rear surface of the door and facing the storage compartment, an upper cap, a lower cap, and a door insulation provided therein.

An edge of the door inner panel may be provided with a gasket that seals the storage compartment by pressing against the front surface of the main body when the door is closed. The door inner panel may include a dyke that protrudes rearward to receive a door basket for storing items.

According to one embodiment, the door may include a door body and a front panel detachably coupled to a front side of the door body and forming the front surface of the door. The door body may include a door outer panel forming a front surface of the door body, a door inner panel forming a rear surface of the door body and facing the storage compartment, an upper cap, a lower cap, and a door insulation provided therein.

Refrigerators may be classified into French door type, side-by-side type, bottom mounted freezer (BMF), top mounted freezer (TMF), or single-door refrigerator according to arrangement of door and storage compartment.

According to one embodiment, the refrigerator may include a cold air supply device configured to supply cold air to the storage compartment.

The cold air supply device may include a system of machines, devices, electronic devices and/or combinations thereof that generate cold air and guide the cold air to cool the storage compartment.

According to one embodiment, the cold air supply device may generate cold air through a refrigeration cycle that includes processes of compression, condensation, expansion, and evaporation of a refrigerant. For this, the cold air supply device may include a refrigeration cycle device including a compressor, a condenser, an expansion device, and an evaporator capable of driving the refrigeration cycle. In one embodiment, the cold air supply device may include a semiconductor, such as a thermoelectric element. The thermoelectric element may cool a storage compartment by generating heat and cooling through the Peltier effect.

According to one embodiment, the refrigerator may include a machine room in which at least some components belonging to the cold air supply device are arranged.

The machine room may be provided to be partitioned and insulated from the storage compartment to prevent heat generated by components disposed within the machine room from being transferred to the storage compartment. An inside of the machine room may be provided to communicate with an outside of the main body to dissipate heat from components disposed within the machine room.

According to one embodiment, the refrigerator may include a dispenser provided on the door to provide water and/or ice. The dispenser may be provided on the door to allow a user to access without having to open the door.

According to one embodiment, the refrigerator may include an ice-making device configured to produce ice. The ice-making device may include an ice-making tray configured to store water, an ice-separating device configured to separate ice from the ice-making tray, and an ice bucket configured to store ice produced in the ice-making tray.

According to one embodiment, the refrigerator may include a controller for controlling the refrigerator.

The controller may include a memory provided to store or memorize a program and/or data for controlling the refrigerator, and a processor configured to output a control signal for controlling a cold air supply device, and the like according to the program and/or data memorized in the memory.

The memory stores or records various information, data, commands, programs, and the like necessary for the operation of the refrigerator. The memory may store temporary data generated during the generation of control signals for controlling components within the refrigerator. The memory may include at least one of volatile memory and non-volatile memory, or a combination thereof.

The processor controls the overall operation of the refrigerator. The processor may control the components of the refrigerator by executing programs stored in the memory. The processor may include a separate Neural Network Processing Unit (NPU) that performs operations of an artificial intelligence model. The processor may also include a central processing unit (CPU), a graphics processing unit (GPU), or the like. The processor may generate control signals to control operations of the cold air supply device. For example, the processor may receive temperature information about the storage compartment from a temperature sensor and generate a cooling control signal to control the operations of the cold air supply device based on the temperature information.

Additionally, the processor may process user input of a user interface and control operations of the user interface according to the programs and/or data stored/stored in the memory. The user interface may be provided using an input interface and an output interface. The processor may receive user input from the user interface. Additionally, the processor may transmit display control signals and image data to the user interface for displaying an image on the user interface in response to the user input.

The processor and memory may be provided integrally or separately. The processor may include one or more processors. For example, the processor may include a main processor and at least one sub-processor. The memory may include one or more memories.

According to one embodiment, the refrigerator may include a processor and a memory configured to control all components within the refrigerator, and may include a plurality of processors and a plurality of memories configured to individually control the components within the refrigerator. For example, the refrigerator may include a processor and a memory configured to control the operation of the cold air supply device based on the output of the temperature sensor. Additionally, the refrigerator may separately include a processor and a memory configured to control the operation of the user interface based on user input.

A communication module may communicate with external devices, such as servers, mobile devices, and other home appliances, via a nearby access point (AP). The AP may connect a local area network (LAN) to which the refrigerator or user device is connected to a wide area network (WAN) to which the server is connected. The refrigerator or user device may be connected to the server via the WAN.

The input interface may include a key, a touchscreen, a microphone, and the like. The input interface may receive user input and transmit the user input to the processor.

The output interface may include a display, a speaker, and the like. The output interface may output various notifications, messages, information, and the like generated by the processor.

Hereinafter exemplary embodiments of the present disclosure will be described in detail with reference to the accompanying drawings.

Meanwhile, the terms “front and rear direction,” “left and right direction,” “upper side,” “lower side,” and the like used in the description below are defined based on the drawing, and the shape and position of each component are not limited by these terms.

For example, the X direction may be defined as the front and rear direction. For example, the Y direction may be defined as the lateral direction. For example, the Z direction may be defined as the up and down direction. For example, the +X direction may be defined as the front side, and the -X direction may be defined as the rear side. For example, the +Y direction may be defined as the left side, and the -Y direction may be defined as the right side. For example, the +Z direction may be defined as the upper side, and the -Z direction may be defined as the lower side. In addition, the front and rear direction, the lateral direction, and the up and down direction may each be defined based on a case in which both an inner door 100 and an outer door 200 of a refrigerator 1 described below are closed, and the following description is made on the assumption that both the inner door 100 and the outer door 200 of the refrigerator 1 are closed.

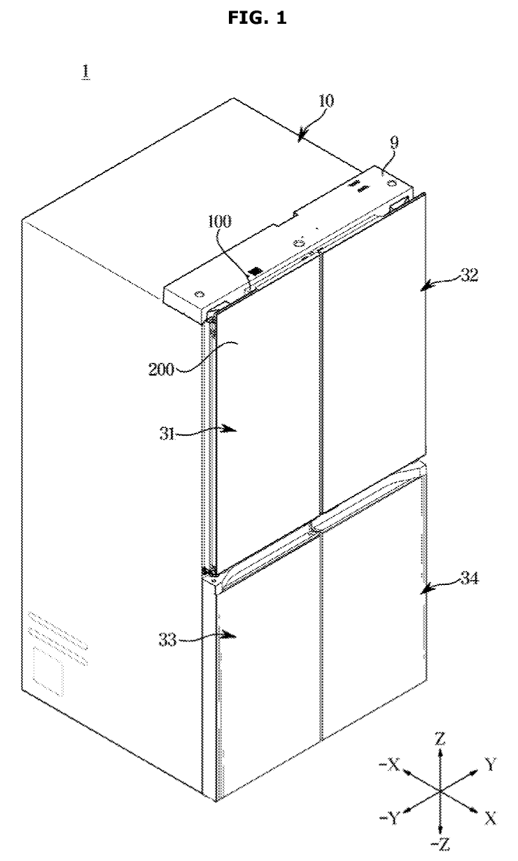

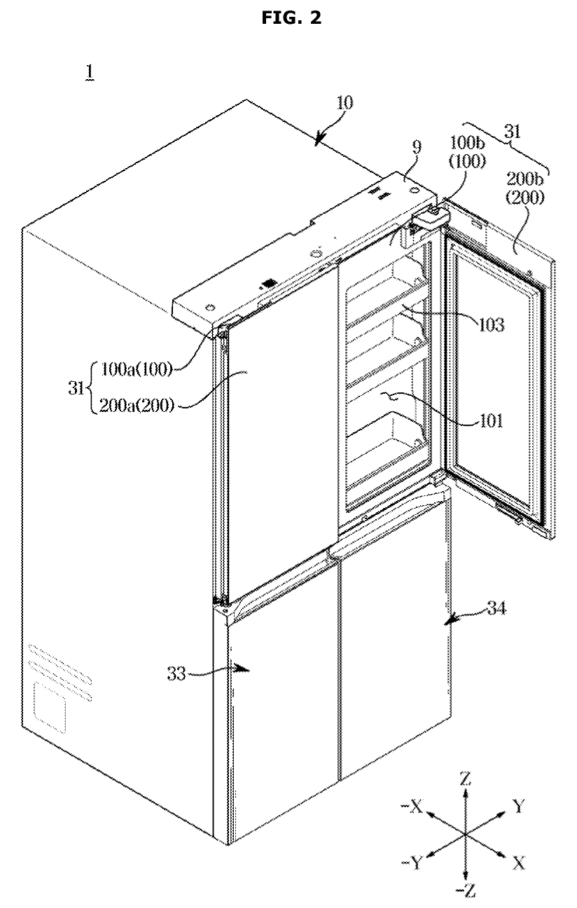

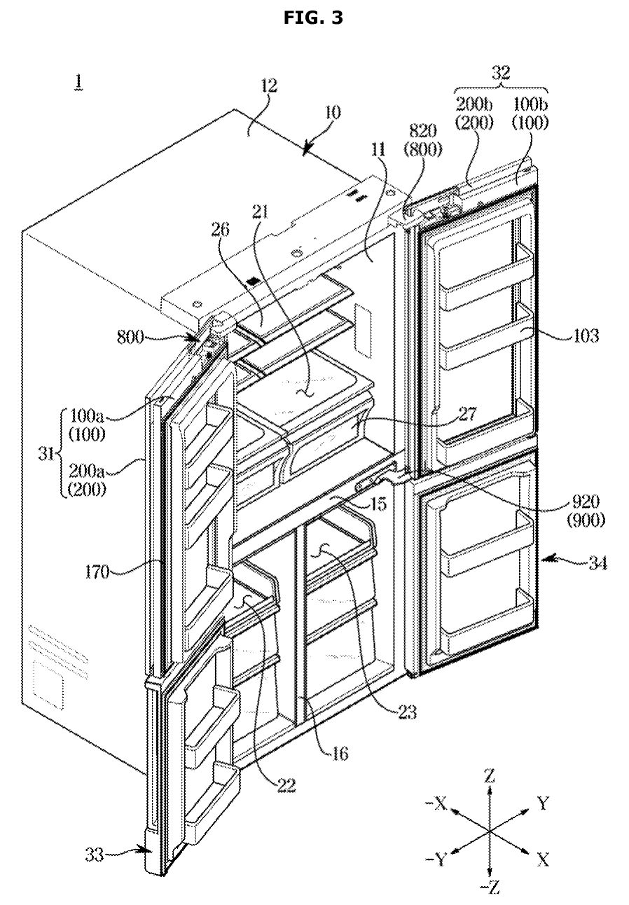

FIG. 1 is a perspective view of a refrigerator according to one embodiment of the present disclosure. FIG. 2 is a perspective view illustrating a state in which an outer door of the refrigerator according to one embodiment of the present disclosure is open. FIG. 3 is a perspective view illustrating a state in which all doors of the refrigerator according to one embodiment of the present disclosure are open.

Referring to FIGS. 1-3, the refrigerator 1 may include a main body 10, storage compartments 21, 22, and 23 formed inside the main body 10, doors 31, 32, 33, and 34 configured to open and close the storage compartments 21, 22, and 23, and a cold air supply device (not shown) configured to supply cold air to the storage compartments 21, 22, and 23.

The main body 10 may include an inner case 11 forming the storage compartments 21, 22, and 23, an outer case 12 coupled to an outside of the inner case 11 to form an exterior, and an insulation (not shown) provided between the inner case 11 and the outer case 12 to insulate the storage compartments 21, 22, and 23. A top cover 9 provided to cover an upper main body hinge may be provided on an upper surface of the main body 10.

The storage compartments 21, 22, and 23 may be divided into a plurality of sections by a horizontal partition wall 15 and a vertical partition wall 16. The storage compartments 21, 22, and 23 may be divided into an upper storage compartment 21 and lower storage compartments 22 and 23 by the horizontal partition wall 15, and the lower storage compartments 22 and 23 may be divided into a lower left storage compartment 22 and a lower right storage compartment 23 by the vertical partition wall 16.

The upper storage compartment 21 may be used as a refrigerating compartment, and the lower storage compartments 22 and 23 may be used as a freezing compartment. However, the division and use of the storage compartments 21, 22, and 23 as described above are only an example and are not limited thereto.

In addition, unlike the present embodiment, the refrigerator may be a Side By Side (SBS) type in which a storage compartment is divided into the left and right by a vertical partition, a French Door Refrigerator (FDR) type in which the storage compartment is divided into an upper refrigerating compartment and a lower refrigerating compartment by a horizontal partition, or a single-door type having one storage compartment and one door.

In the storage compartments 21, 22, and 23, a shelf 26 and a storage container 27 may be provided.

The cold air supply device may generate cold air by using a cooling circulation cycle of compressing, condensing, expanding, and evaporating a refrigerant, and supply the generated cold air to the storage compartments 21, 22, and 23.

The upper storage compartment 21 may be opened and closed by a pair of doors 31 and 32. The pair of doors 31 and 32 may be rotatably coupled to the main body 10. The pair of doors 31 and 32 may include a left upper door 31 and a right upper door 32.

One of the pair of doors 31 and 32 may be provided with a rotating bar (not shown) to prevent cold air of the storage compartment 21 from leaking between the pair of doors 31 and 32 when the pair of doors 31 and 32 is closed.

The lower left storage compartment 22 may be opened and closed by the lower left door 33, and the lower left door 33 may be rotatably coupled to the main body 10. The lower right storage compartment 23 may be opened and closed by the lower right door 34, and the lower right door 34 may be rotatably coupled to the main body 10.

At least one of the doors 31, 32, 33, and 34 may be configured as a double door including an inner door and an outer door. For example, the upper left door 31 may include an inner door 100a and an outer door 200a. For example, the upper right door 32 may include an inner door 100b and an outer door 200b.

However, the present disclosure is not limited thereto. For example, each of the lower left door 33 and the lower right door 34 may be configured as a double door including an inner door and an outer door.

However, for the convenience of description, in the following, in the case of a common description that does not require distinction between a plurality of components included in the doors 31, 32, 33, and 34, the symbols “a” and “b” may not be indicated in the drawing. For example, a description of the inner door 100 may be a description common to both the inner door 100a of the upper left door 31 and the inner door 100b of the upper right door 32. For example, a description of the outer door 200 may be a description common to both the outer door 200a of the upper left door 31 and the outer door 200b of the upper right door 32.

Accordingly, the configuration and features of each of the inner door 100 and the outer door 200 described later may be commonly applied to each of the inner and outer doors of the upper left door 31, the upper right door 32, the lower left door 33, and the lower right door 34.

The inner door 100 may be configured to be rotatable in the front of the main body 10. The inner door 100 may be rotatably coupled to the main body 10 via a main body hinge.

The inner door 100 may include a door opening 101. The door opening 101 may be formed to penetrate a central portion of the inner door 100 in the front and rear direction. With the configuration, the door opening 101 may be connected to the upper storage compartment 21.

The outer door 200 may be rotatably coupled to the inner door 100 via a lower second hinge 400 and an upper first hinge 300 which will be described later.

The outer door 200 may rotate in the same direction as the inner door 100. The outer door 200 may have a size corresponding to a size of the inner door 100. The outer door 200 may cover the entire area of the inner door 100.

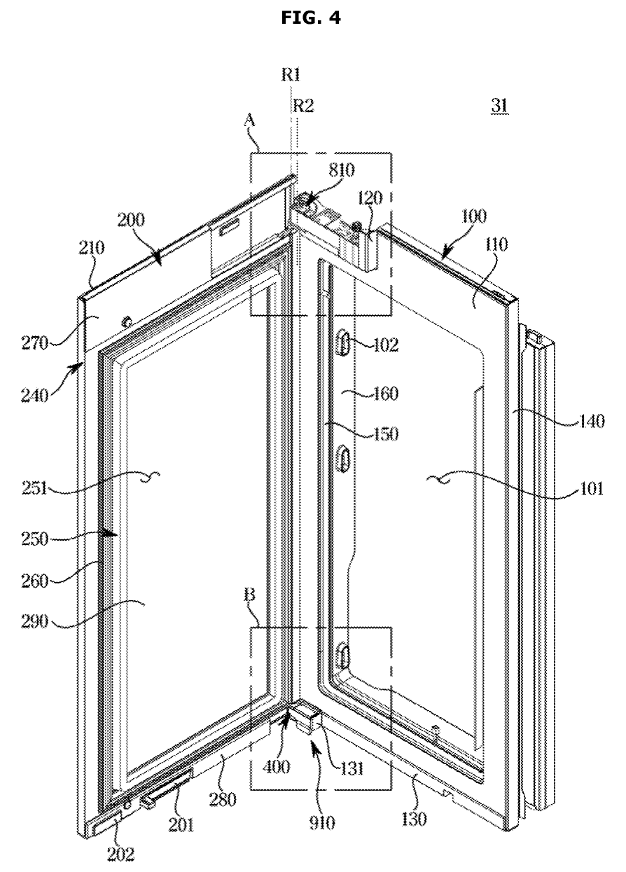

Hereinafter the specific configuration of the inner door 100 and the outer door 200 will be described with reference to FIGS. 4-7.

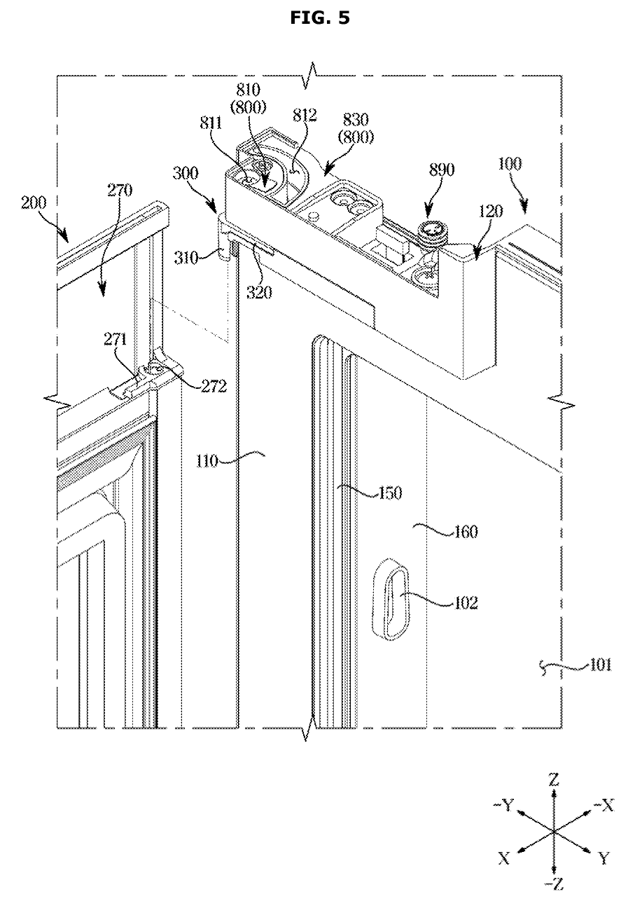

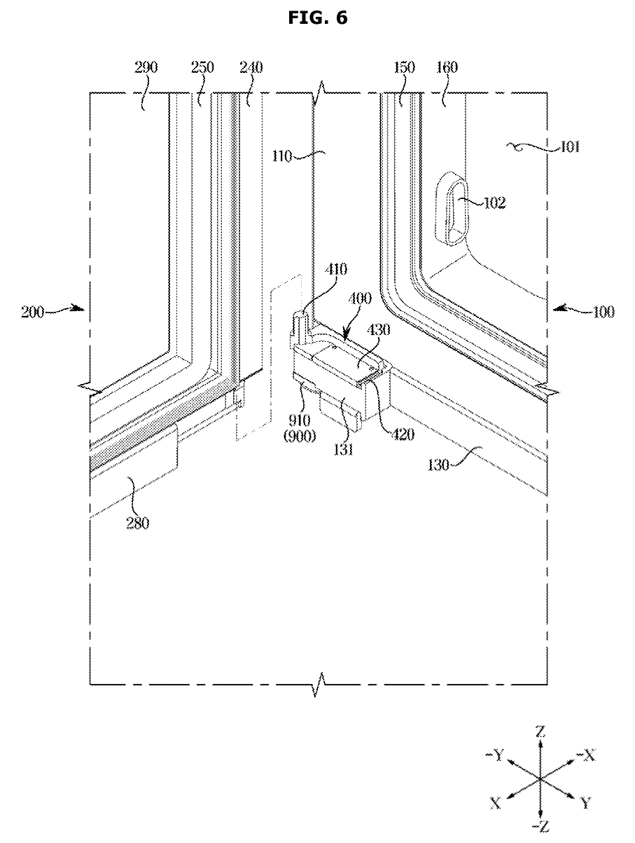

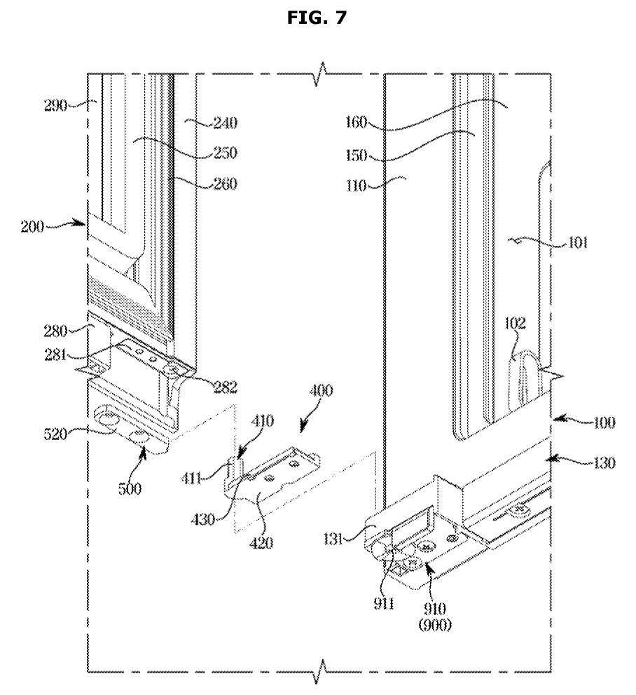

FIG. 4 is a perspective view illustrating a state in which the outer door is open in the door of the refrigerator according to one embodiment of the present disclosure. FIG. 5 is an enlarged-perspective view of a region corresponding to a region A of FIG. 4, illustrating a state in which the outer door is separated from an inner door in the door of the refrigerator according to one embodiment of the present disclosure. FIG. 6 is an enlarged-perspective view of a region corresponding to a region B of FIG. 4, illustrating a state in which the outer door is separated from the inner door in the door of the refrigerator according to one embodiment of the present disclosure. FIG. 7 is an enlarged-perspective view of a region corresponding to the region B of FIG. 4 when viewed from a different direction, illustrating a state in which the door according to one embodiment of the present disclosure is disassembled into some components.

Referring to FIGS. 4-7, the inner door 100 may include a front plate 110. The front plate 110 may be provided at a front portion of the inner door 100. The front plate 110 may form a front surface of the inner door 100.

An opening may be formed on the front plate 110. The opening of the front plate 110 may be provided on the inside of the front plate 110. The opening of the front plate 110 may be formed to penetrate a central portion of the front plate 110 in the front and rear direction.

The inner door 100 may include door caps 120 and 130. The door caps 120 and 130 may include a first door cap 120 coupled to an upper portion of the front plate 110 and a second door cap 130 coupled to a lower portion of the front plate 110.

The first door cap 120 may be provided on the upper portion of the front plate 110, and the second door cap 130 may be provided on the lower portion of the front plate 110.

The first door cap 120 may be provided on an upper end of the inner door 100. The first door cap 120 may form an upper surface of the inner door 100.

The second door cap 130 may be provided at a lower end of the inner door 100. The second door cap 130 may form a lower surface of the inner door 100.

The inner door 100 may include a door chassis 140. The door chassis 140 may be provided at one end of the inner door 100. The door chassis 140 may form one lateral surface of the inner door 100. Particularly, the door chassis 140 may be provided at a right end or a left end of the inner door 100. The door chassis 140 may form a right surface or a left surface of the inner door 100.

The door chassis 140 may be coupled to one side of the front plate 110. The door chassis 140 may be provided on one side of the front plate 110.

The inner door 100 may include a trim 150. The trim 150 may be coupled to a rear surface of the front plate 110. The trim 150 may be provided at a rear side of the front plate 110.

The trim 150 may extend along an edge of the opening formed in the front plate 110. Accordingly, an opening provided to penetrate a central portion in the front and rear direction may be formed in the trim 150.

The inner door 100 may include a door liner 160. The door liner 160 may be provided at a rear side of the front plate 110 and the trim 150. A basket support 102 may be provided on the door liner 160.

The door liner 160 may extend along the edge of the opening formed in the front plate 110. Accordingly, the door liner 160 may form an opening corresponding to the opening formed in the trim 150.

The openings formed in the front plate 110, the trim 150, and the door liner 160 may correspond to each other. The openings formed in the front plate 110, the trim 150, and the door liner 160 may communicate with each other. Accordingly, the door opening 101 may be formed in the inner door 100.

The inner door 100 may include a door gasket 170 (refer to FIG. 3). The door gasket 170 may be provided to seal between the main body 10 and the inner door 100 when the inner door 100 is closed. The door gasket 170 may be coupled to a rear surface of the door liner 160.

The door gasket 170 may extend along the edge of the inner door 100. The door gasket 170 may be provided along an edge of the door liner 160.

The inner door 100 may include the basket support 102 provided to receive a door basket 103 (refer to FIG. 2) for receiving items. The basket support 102 may be provided on the door liner 160.

The basket support 102 may be provided along an edge of the door opening 101. The basket support 102 may protrude from a surface, which faces the opening 110, of the inner door 100

The outer door 200 may include a front panel 210 forming the front surface of the outer door 200, side chassis 240 forming opposite side surfaces of the outer door 200, a liner 250 forming a rear edge of the outer door 200, an upper cap 270, and a lower cap 280.

The side chassis 240 may form opposite side surfaces of the outer door 200. The side chassis 240 may be formed of a metal material. The side chassis 240 may have a quadrangular frame shape.

The side chassis 240 may be provided to be coupled to the front panel 210. The side chassis 240 may include a chassis front portion that is bent to face forward. The side chassis 240 may be provided to be coupled to the liner 250. The side chassis 240 may include a chassis rear portion that is bent to face rearward.

The liner 250 may form a portion of a rear surface of the outer door 200. The liner 250 may include a liner opening 251. The liner opening 251 may be provided on an inner side of the liner 250. The liner opening 251 may be provided in a central portion of the liner 250.

A gasket 260 may be mounted on a rear surface of the liner 250. A gasket mounting portion may be formed to be recessed on the rear surface of the liner 250.

The gasket 260 may extend along an edge of the outer door 200. The gasket 260 may extend along an edge of the liner 250.

The gasket 260 may be formed of an elastic material such as rubber. When the outer door 200 is closed, the gasket 260 may be in close contact with the front surface of the inner door 100. When the outer door 200 is closed, the gasket 260 may be in close contact with a periphery of the door opening 101 on the front surface of the inner door 100 to seal the door opening 101.

The outer door 200 may include a rear panel 290. The rear panel 290 may be provided in a rear portion of the outer door 200. The rear panel 290 may form the rear surface of the outer door 200. The rear panel 290 may be provided at a rear side of the front panel 210.

The rear panel 290 may be provided to cover the liner opening 251 of the liner 250. The rear panel 290 may be provided in a shape corresponding to the liner opening 251.

The upper cap 270 may be coupled to upper ends of the front panel 210 and the liner 250.

The lower cap 280 may be coupled to lower ends of the front panel 210 and the liner 250.

The outer door 200 may include an insulating panel. The insulating panel may be provided to insulate the refrigerator 1. For example, the insulating panel may include a vacuum insulating panel.

The insulation panel may be provided on an inside of the outer door 200. The insulation panel may be received in a receiving space formed by the front panel 210, the side chassis 240, the upper cap 270, the lower cap 280, the liner 250, and the rear panel 290. The receiving space may be provided on the inside of the outer door 200. For example, the insulation panel may be provided in a central portion of the receiving space.

Meanwhile, the outer door 200 may additionally include a component for insulating the refrigerator 1 in addition to the insulation panel. For example, the outer door 200 may further include a separate insulation panel distinct from the insulation panel, or an insulation material such as foamed urethane. In addition to the insulation panel, the component for insulating the refrigerator 1 may be received in a space formed inside the outer door 200 other than a space occupied by the insulation panel.

The outer door 200 may include an opening and closing device 201. The opening and closing device 201 may be configured to open and close the outer door 200.

The opening and closing device 201 may be positioned at a lower end of the outer door 200. At least a portion of the opening and closing device 201 may be provided to be accessible from the outside of the refrigerator 1.

The outer door 200 may include a touch sensor 202. The touch sensor 202 may be provided to detect a user's touch and open the inner door 100. For example, when the inner door 100 is closed, a user can open the inner door 100 by touching the touch sensor 202.

The touch sensor 202 may be positioned at the lower end of the outer door 200. At least a portion of the touch sensor 202 may be provided at the lower side of the outer door 200 so as to be accessible from the outside of the refrigerator 1.

The refrigerator 1 may include an upper hinge device 800. The upper hinge device 800 may be coupled to an upper side of the main body 10. The upper hinge device 800 may be coupled to the upper side of the inner door 100. The upper hinge device 800 may rotatably connect the inner door 100 to the main body 10. The upper hinge device 800 may rotatably support the inner door 100.

The upper hinge device 800 may include an upper body hinge 820 coupled to the main body 10, and an upper door hinge 810 coupled to the inner door 100.

The upper door hinge 810 may be provided on the upper portion of the inner door 100. The upper door hinge 810 may be coupled to the first door cap 120. The upper door hinge 810 may be coupled to one side of an upper surface of the first door cap 120.

For example, the upper hinge device 800 may include an upper hinge case 830 provided to couple the upper door hinge 810 to the first door cap 120. The upper hinge case 830 may be coupled to an upper side of the first door cap 120. The upper door hinge 810 may be coupled to the upper hinge case 830. Accordingly, the upper hinge case 830 may mediate the coupling of the first door cap 120 and the upper door hinge 810.

The first door cap 120 may include a first hinge mounting portion 121 on one side thereof. The first hinge mounting portion 121 may be provided on one lateral portion of the first door cap 120. In the first hinge mounting portion 121, a mounting space, in which the upper hinge case 830 may be received, may be formed. The upper hinge case 830 may be received in the first hinge mounting portion 121 and mounted on the first door cap 120.

The upper hinge case 830 may be provided on an upper side of the upper door hinge 810. That is, the upper door hinge 810 may be coupled to a lower side of the upper hinge case 830. Accordingly, the upper hinge case 830 may be provided to allow at least a portion of the upper door hinge 810 to be exposed upward. An upper hinge shaft coupling hole 811 and a guide groove 812 of the upper door hinge 810 may be exposed to an upper side of the upper hinge case 830.

The upper door hinge 810 may be provided to be rotatably coupled to the upper body hinge 820. For example, the upper body hinge 820 may be provided with a hinge shaft that is inserted into the upper door hinge 810. The upper door hinge 810 may include the upper hinge shaft coupling hole 811 into which the hinge shaft of the upper body hinge 820 is inserted.

The upper hinge device 800 may be provided to prevent a rotation axis of the inner door 100 from being twisted or from sagging due to a load that is received as the inner door 100 rotates. The upper door hinge 810 may include the guide groove 812 provided around the upper hinge shaft coupling hole 811. The guide groove 812 may be provided to be spaced apart from the upper hinge shaft coupling hole 811 by a predetermined distance. The upper body hinge 820 may include a protruding structure inserted into the guide groove 812. Accordingly, the protruding structure of the upper body hinge 820 may be relatively rotated and moved within the guide groove 812 of the upper door hinge 810 as the inner door 100 rotates.

The first hinge mounting portion 121 may be a substantially basket shape in which a mounting space is formed. The first hinge mounting portion 121 may have a shape in which at least one side thereof protrudes forward with respect to the first door cap 120. The first hinge 300 provided to rotatably couple the outer door 200 and the inner door 100 may be coupled to a lower side of the first hinge mounting portion 121.

The first hinge 300 that rotatably couples the outer door 200 and the inner door 100 may be provided on a lower side of the upper hinge device 800. The first hinge 300 may be provided on one side of a lower surface of the first door cap 120.

The first hinge 300 rotatably coupled to the outer door 200 may include a first shaft 310 and a first plate 320. The first plate 320 of the first hinge 300 may be coupled to a lower surface of the first hinge mounting portion 121 of the first door cap 120.

An upper hinge receiving portion 271 to which the first hinge 300 is coupled may be provided in the upper cap 270 of the outer door 200. The first hinge 300 may include the first shaft 310 forming a rotation axis R1 of the outer door 200. An upper insertion hole 272, into which the first shaft 310 is inserted, may be formed on the upper hinge receiving portion 271.

The upper hinge receiving portion 271 may be provided separately from the upper cap 270 and may be coupled to the upper cap 270. The upper hinge receiving portion 271 may be coupled to an upper surface of the upper cap 270 that is formed as a rear surface of the upper cap 270 is recessed forward.

The refrigerator 1 may include a lower hinge device 900. The lower hinge device 900 may be coupled to a lower side of the inner door 100. The lower hinge device 900 may rotatably connect the inner door 100 to the main body 10. The lower hinge device 900 may rotatably support the inner door 100.

The lower hinge device 900 may include a lower body hinge 990 coupled to the main body 10 and a lower door hinge 910 coupled to the inner door 100.

The lower door hinge 910 may be provided in a lower portion of the inner door 100. The lower door hinge 910 may be coupled to the second door cap 130. The lower door hinge 910 may be provided on one side of a lower surface of the second door cap 130.

For example, the second door cap 130 may include a second hinge mounting portion 131 formed to protrude forward on one lateral side. The lower door hinge 910 may be coupled to a lower surface of the second hinge mounting portion 131. A lower hinge shaft coupling hole 911 of the lower door hinge 910 may be formed to extend into an inside of the second hinge mounting portion 131.

The lower door hinge 910 may be configured to be rotatably coupled to the lower body hinge 990. For example, the lower body hinge 990 may be provided with a hinge shaft that is inserted into the lower door hinge 910. The lower door hinge 910 may include the lower hinge shaft coupling hole 911 into which the hinge shaft of the lower body hinge 990 is inserted.

The second hinge 400 that rotatably couples the outer door 200 and the inner door 100 may be provided on an upper side of the lower hinge device 900. The second hinge 400 may be provided on one side of an upper surface of the second door cap 130.

Particularly, the second hinge 400 may be coupled to an upper surface of the second hinge mounting portion 131 formed on one lateral side of the second door cap 130.

The second hinge 400 rotatably coupled to the outer door 200 may include a second shaft 410 and a second plate 420. The second plate 420 of the second hinge 400 may be coupled to the upper surface of the second hinge mounting portion 131 of the second door cap 130.

The lower cap 280 may be provided with a lower hinge receiving portion 281 to which the second hinge 400 is coupled. The second hinge 400 may include the second shaft 410 that forms the rotation axis R1 of the outer door 200. A lower insertion hole 282 into which the second shaft 410 is inserted may be formed in the lower hinge receiving portion 281.

The lower hinge receiving portion 281 may be provided separately from the lower cap 280. The lower hinge receiving portion 281 may be coupled to a lateral side end of the lower cap 280. At least a portion of a lower surface of the lower hinge receiving portion 281 may be exposed downward from the lower surface of the lower cap 280.

The first hinge 300 may be arranged vertically with respect to the upper door hinge 810. The second hinge 400 may be arranged vertically with respect to the lower door hinge 910. Accordingly, the rotation axis R1 of the outer door 200 formed by the first hinge 300 and the second hinge 400 and a rotation axis R2 of the inner door 100 formed by the upper door hinge 810 and the lower door hinge 910 may be formed adjacent to each other. Accordingly, a thickness of the door 31 including the inner door 100 and the outer door 200 may be reduced.

Meanwhile, the refrigerator 1 according to one embodiment of the present disclosure may be provided to allow an opening angle of the outer door 200 to be limited. The door 31 of the refrigerator 1 may include the second hinge 400 including a rotation limiter 411, and a stopper 500 provided to correspond to the rotation limiter 411.

The second hinge 400 including the rotation limiter 411 may be coupled to the inner door 100. The stopper 500 may be coupled to the outer door 200.

For example, the second hinge 400 may be fixed to the upper surface of the second hinge mounting portion 131 provided on the inner door 100. Accordingly, the second hinge 400 may be fixed to the inner door 100. The second hinge 400 may be moved together with the inner door 100.

Particularly, a fastening hole may be formed in the second plate 420 of the second hinge 400 so as to be fastened to the second hinge mounting portion 131 through a screw. The second hinge 400 may be fastened to an upper surface of the upper hinge receiving portion 271 through a screw.

The second hinge 400 may include a second hinge cover 430 provided to cover at least a portion of the second plate 420. The second hinge cover 430 may be provided to cover a screw fastening portion of the second hinge 400.

For example, the stopper 500 may be fixed by being coupled to the lower surface of the lower hinge receiving portion 281 provided on the outer door 200. Accordingly, the stopper 500 may be fixed to the outer door 200. The stopper 500 may be moved together with the outer door 200.

Particularly, a fastening hole may be formed in the main body 520 of the stopper 500 to be fastened to the lower surface of the lower hinge receiving portion 281 through a screw. The stopper 500 may be fastened to the lower hinge receiving portion 281 through a screw.

Accordingly, in a process of the outer door 200 being opened, when the stopper 500 interferes with the rotation limiter 411 of the second hinge 400 and rotation is limited, the rotation of the outer door 200 may also be limited.

That is, the second hinge 400 and the stopper 500 may be provided between the inner door 100 and the outer door 200 to limit the opening angle of the outer door 200. In other words, the second hinge 400 and the stopper 500 may be provided inside the door 31.

A specific operation manner of the stopper 500 and the rotation limiter 411 of the second hinge 400 are described later in other drawings.

In the embodiment of the present disclosure, it is illustrated that the second hinge 400 including the stopper is formed in the lower portion of the inner door 100, and the corresponding stopper 500 is formed in the lower portion of the outer door 200. However, the present disclosure is not limited thereto. For example, the configuration of the hinge including the rotation limiter 411 to limit the opening angle of the outer door 200 and the corresponding stopper 500 may be formed at the upper portions of the inner door 100 and the outer door 200.

In addition, in the embodiment of the present disclosure, it is illustrated that the configuration of the second hinge 400 including the rotation limiter 411 and the corresponding stopper 500 are provided between the inner door 100 and the outer door 200 to limit the opening angle of the outer door 200, but the present disclosure is not limited thereto. For example, the configuration of the second hinge 400 including the stopper and the corresponding stopper 500 may be provided between the main body 10 and the inner door 100 or between the main body 10 and the door to limit the opening angle of the inner door 100 or the door, respectively.

However, for the convenience of description, the second hinge 400 provided at the lower portion of the inner door 100 and the stopper 500 provided at the lower portion of the outer door 200 will be described below.

In addition, for the convenience of description, the expressions “first” and “second” may not be used hereinafter. For example, the description of the hinge described below may be applied to the description of the second hinge 400.

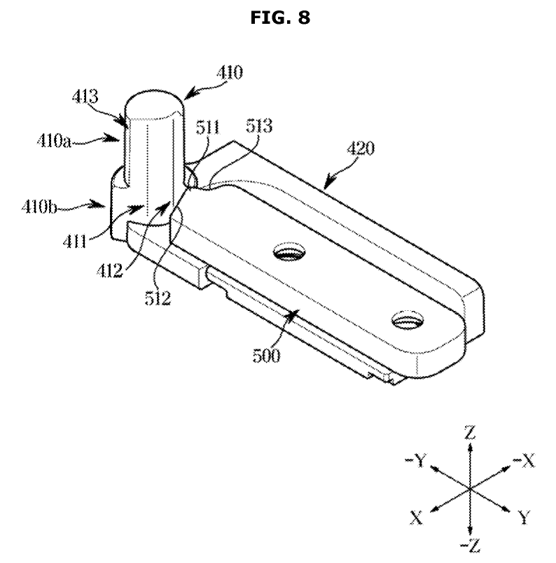

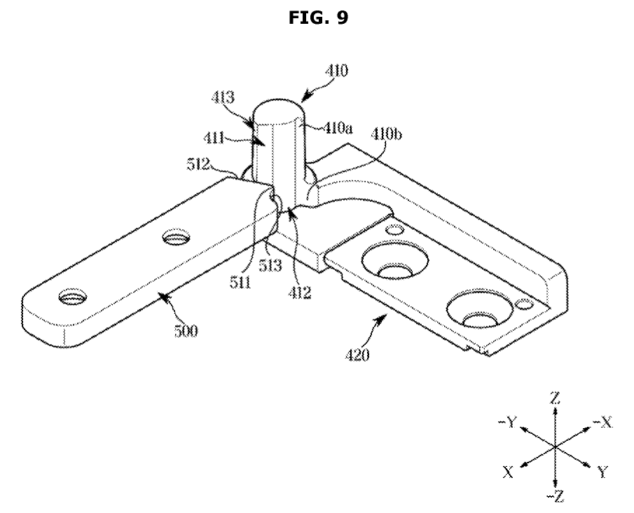

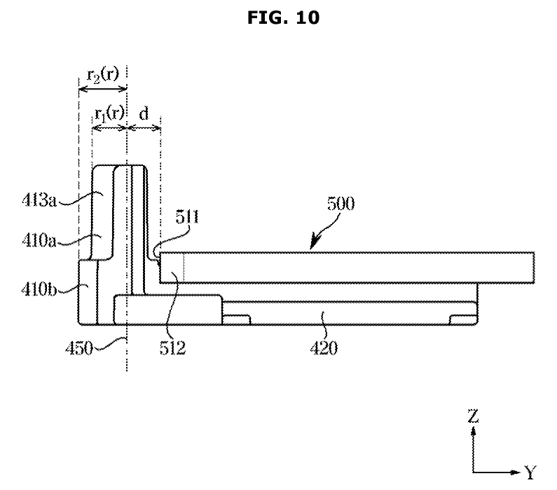

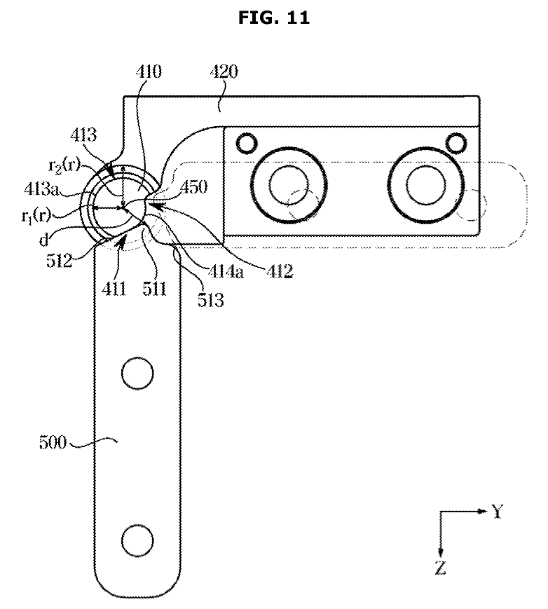

FIG. 8 is a perspective view of a hinge and a stopper according to one embodiment of the present disclosure. FIG. 9 is a perspective view of the hinge and the stopper according to one embodiment of the present disclosure. FIG. 10 is a front view of the hinge and the stopper according to one embodiment of the present disclosure. FIG. 11 is a top view of the hinge and the stopper according to one embodiment of the present disclosure.

Referring to FIGS. 8-11, the hinge 400 may include the shaft 410 and the plate 420. The shaft 410 and the plate 420 may be integrated with each other. The rotation limiter 411 may be provided on the shaft 410 of the hinge 400.

The stopper 500 may be configured to rotationally move around a circumference of the shaft 410. The rotation limiter 411 may be provided to prevent the stopper 500 from rotating beyond a certain angle when the stopper 500 rotates.

Accordingly, the hinge 400 and the stopper 500 may be respectively coupled to the inner door 100 and the outer door 200 to control the opening angle of the outer door 200.

Particularly, the shaft 410 may be configured to allow the stopper 500 to rotationally move along the circumference of the shaft 410 and to interfere with the shaft 410 at a specific angle.

The shaft 410 may include the rotation limiter 411 and a rotation guide portion 412. The rotation limiter 411 and the rotation guide portion 412 may be arranged in a circumferential direction of the shaft 410. The rotation limiter 411 may be provided at one end of the rotation guide portion 412. A direction in which the rotation limiter 411 is positioned with respect to the rotation guide portion 412 may be the same as a direction in which the stopper 500 rotates in response to the outer door 200 being opened.

The stopper 500 may be rotationally moved along the rotation guide portion 412. When the stopper 500 forms a specific angle with the hinge 400, interference may occur with the rotation limiter 411. Accordingly, the opening angle of the outer door 200 may be controlled.

The rotation limiter 411 and the rotation guide portion 412 may be formed by recessing a portion of the shaft 410 inwardly beyond the radius of the shaft 410. The rotation guide portion 412 may be formed by retracting an outer circumferential surface of the shaft 410 along a radius of movement of the stopper 500.

Particularly, an outer circumferential surface portion 413 of the shaft 410 may include a first outer circumferential surface 413a and a second outer circumferential surface 414a. The first outer circumferential surface 413a may be a portion of the outer circumferential surface portion 413 of the shaft 410 that is provided to have a constant radius (r) along the circumferential direction.

The second outer circumferential surface 414a may be a portion of the outer circumferential surface portion 413 of the shaft 410 in which a distance from a center 450 of the shaft changes along the circumferential direction. Accordingly, the second outer circumferential surface 414a may be provided as a curved surface and/or a flat surface. Distances between all portions of the second outer circumferential surface 414a and the center 450 of the shaft may be provided to be less than a radius (r) of the first outer circumferential surface 413a.

The shaft 410 may include the rotation limiter 411, the rotation guide portion 412, and the outer circumferential surface portion 413. The outer circumferential surface portion 413 may refer to a portion of the shaft 410 except for the rotation limiter 411 and the rotation guide portion 412 with respect to the circumferential direction.

The rotation limiter 411 may be provided between the outer circumferential surface portion 413 and the rotation guide portion 412. The rotation limiter 411 may be provided in such a way that the outer circumferential surface portion 413 and the rotation guide portion 412 are stepped from each other. The rotation limiter 411 may extend from one end of the rotation guide portion 412, which is with respect to the circumferential direction, to the outer circumferential surface portion 413.

The outer circumferential surface portion 413 may be a portion of the shaft 410 in which the first outer circumferential surface 413a is formed. Accordingly, the outer circumferential surface portion 413 may be provided to have the constant radius (r) along the circumferential direction.

The rotation guide portion 412 and the rotation limiter 411 may be a portion of the shaft 410 in which the second outer circumferential surface 414a is formed.

A distance from the center 450 of the shaft 410 to the rotation guide portion 412 may be less than a radius (r) of the outer circumferential surface portion 413 of the shaft 410.

A distance from the center 450 of the shaft 410 to the rotation limiter 411 may be less than the radius (r) of the outer circumferential surface portion 413 of the shaft 410.

In other words, the rotation limiter 411 may be formed in an inner region of a radius (r) of the shaft 410. Accordingly, the hinge 400 according to one embodiment of the present disclosure may form the rotation limiter 411 without increasing the size of the shaft 410. That is, while forming the rotation limiter 411 in the hinge 400 to control the opening angle of the outer door 200, it is possible to maintain a relatively small thickness of the door 31.

Meanwhile, the shaft 410 may include a rotation shaft portion 410a and a reinforcing portion 410b provided in a direction of a central axis. The shaft 410 may include the rotation shaft portion 410a inserted into the outer door 200, and the reinforcing portion 410b positioned between the rotation shaft portion 410a and the plate 420. A radius of the reinforcing portion 410b may be provided to be greater than a radius of the rotation shaft portion 410a.

The reinforcing portion 410b may be provided at a lower portion of the rotation shaft portion 410a. The reinforcing portion 410b may be provided to support the lower surface of the outer door 200 into which the rotation shaft portion 410a is inserted and coupled.

The shaft 410 may be provided in a shape that protrudes to one side from the plate 420. As the shaft 410 includes the reinforcing portion 410b, an area of a portion, in which the shaft 410 and the plate 420 are connected to each other, may be increased. Accordingly, a structural strength of the hinge 400 may be increased, thereby increasing coupling stability of the inner door 100 and the outer door 200 that are coupled to each other through the hinge 400.

The hinge 400 may control the opening angle of the outer door 200 by interfering with the stopper 500. The rotation limiter 411 of the hinge 400 and the stopper 500 may be provided to come into surface contact with each other when interfering. Accordingly, the rotation limiter 411 may include a surface shape.

The stopper 500 may include a contact surface 512 so as to be in surface contact with the rotation limiter 411. The rotation limiter 411 of the hinge 400 may also be provided so as to be in surface contact with the contact surface 512 of the stopper 500. Accordingly, as the rotation limiter 411 and the stopper 500 come into surface contact and interfere with each other, the structural stability and durability may be improved in comparison with the interference through line contact or point contact. Particularly, in the case of surface contact, the contact area may be wider than in the case of point contact or line contact, and thus a stress dispersing effect may be increased.

For example, the rotation limiter 411 may be provided in a flat shape. Both the rotation shaft portion 410a and the reinforcing portion 410b of the shaft 410 may include the rotation limiter 411. The rotation limiter 411 may be provided to be continuous in one plane over a portion of the rotation shaft portion 410a and a portion of the reinforcing portion 410b.

The reinforcing portion 410b and the rotation shaft portion 410a may be in surface contact and interfere with the stopper 500. As the rotation limiter 411 is also formed in the reinforcing portion 410b, an area in surface contact with each other when interfering with the stopper 500 may be increased. Accordingly, the stability may be increased compared to a case in which interference with the stopper 500 occurs only through the rotation limiter 411 formed on the rotation shaft portion 410a.

As the rotation limiter 411 is provided in a common plane to the rotation shaft portion 410a and the reinforcing portion 410b, a machining process for forming the rotation limiter 411 on the shaft 410 may be facilitated.

For example, the rotation guide portion 412 may be provided in a curved shape. Both the rotation shaft portion 410a and the reinforcing portion 410b of the shaft 410 may include the rotation guide portion 412. The rotation guide portion 412 may be provided to extend as a single curved surface over a portion of the rotation shaft portion 410a and a portion of the reinforcing portion 410b and thus the stopper 500 may be rotationally moved up to a limit angle without interference.

Hereinafter an operation principle of the rotation limiter 411 of the hinge 400 will be particularly described.

In response to the outer door 200 being closed, the stopper 500 may be positioned on the plate 420 of the hinge 400. At this time, an end portion 511 of the stopper 500 may be provided at one end in a circumferential direction of the rotation guide portion 412 of the shaft 410 of the hinge 400. The end portion 511 of the stopper 500 may be provided to face the rotation guide portion 412 of the shaft 410.

In response to the outer door 200 being opened, the stopper 500 may be rotationally moved forward along the circumference of the shaft 410 of the hinge 400. At this time, the stopper 500 may be rotationally moved along the rotation guide portion 412 of the shaft 410.

In response to the outer door 200 reaching a limit angle, the stopper 500 may interfere with the shaft 410 of the hinge 400. The stopper 500 may come into contact and interfere with the rotation limiter 411 of the shaft 410.

Particularly, the stopper 500 may include the end portion 511 formed on a surface facing the shaft 410 and the contact surface 512 extending from the end portion 511. That is, the contact surface 512 may be formed on a surface of the stopper 500 facing the shaft 410.

The stopper 500 may form a shortest distance from the end portion 511 to the center 450 of the shaft 410. That is, the end portion 511 may be provided to allow a distance from the stopper 500 to the center 450 of the shaft 410 to be the shortest. That is, the distance from the center 450 of the shaft 410 to the stopper 500 may be the minimum when it is a distance from the center 450 of the shaft 410 to the end portion 511.

The outer door rotation axis R1 (refer to FIG. 4) may be aligned with the center 450 of the shaft 410. Accordingly, the end portion 511 of the stopper 500 that is rotationally moved together with the outer door 200 may be rotationally moved while maintaining a constant distance (d) from the center 450 of the shaft 410.

The stopper 500 may be arranged to be spaced apart from the rotation guide portion 412 of the shaft 410. Accordingly, the stopper 500 may be moved without interference when being rotationally moved along the rotation guide portion 412.

Particularly, a distance from the center 450 of the shaft 410 to the end portion 511 of the stopper 500 may be set to be greater than a distance from the center 450 of the shaft 410 to the rotation guide portion 412 of the shaft 410. Accordingly, when the stopper 500 is rotationally moved along the rotation guide portion 412, the stopper may be maintained at a state of being separated from the rotation guide portion 412.

The stopper 500 may be provided to interfere with the rotation limiter 411 of the shaft 410. The end portion 511 of the stopper 500 may be in contact with the rotation limiter 411. Accordingly, the rotational movement of the stopper 500 may be limited at the rotation limiter 411.

Particularly, the distance from the center 450 of the shaft 410 to the end portion 511 of the stopper 500 may be set to be less than the radius (r) of the shaft 410. That is, the end portion 511 of the stopper 500 may be set to be located inside the radius (r) of the shaft 410.

The shaft 410 may include the rotation shaft portion 410a and the reinforcing portion 410b. Accordingly, the radius of the shaft 410 may include a first radius of the rotation shaft portion 410a and a second radius of the reinforcing portion 410b. The distance from the center 450 of the shaft 410 to the end portion 511 of the stopper 500 may be set to be less than the first radius and/or the second radius.

The first radius may be less than the second radius.

Particularly, when the distance from the center 450 of the shaft 410 to the end portion 511 is less than the first radius, the stopper 500 may interfere with both the rotation limiter 411 formed in the rotation shaft portion 410a and the rotation limiter 411 formed in the reinforcing portion 410b, and thus the rotational movement of the stopper 500 may be limited. Accordingly, the area of surface contact between the rotation limiter 411 and the stopper 500 may increase.

When the distance from the center 450 of the shaft 410 to the end portion 511 is greater than the first radius and less than the second radius, the stopper 500 may only interfere with the rotation limiter 411 formed in the reinforcing portion 410b to limit the rotational movement. Accordingly, the area of contact between the rotation limiter 411 and the stopper 500 may be reduced. However, the position of the stopper 500 may be positioned relatively far from the rotation guide portion 412, and thus a defect rate due to tolerance in the manufacturing process may be reduced.

The rotation limiter 411 of the shaft 410 may be provided between the rotation guide portion 412 and the outer circumferential surface portion 413. The rotation limiter 411 may be provided to connect one end of the rotation guide portion 412 and one end of the outer circumferential surface portion 413. One end, which is with respect to the circumferential direction, of the rotation limiter 411 may be connected to the rotation guide portion 412, and the other end of the rotation limiter 411 may be connected to the outer circumferential surface portion 413. The rotation limiter 411 may be provided to allow the rotation guide portion 412 and the outer circumferential surface portion 413 to be stepped. Accordingly, the distance from the center 450 of the shaft 410 to the rotation limiter 411 may gradually increase in the circumferential direction.

Particularly, the distance from the center 450 of the shaft 410 to the rotation limiter 411 may be continuously changed in the circumferential direction from the minimum distance, which is the distance from the center 450 of the shaft 410 to the rotation guide portion 412, to the maximum distance, which is the distance from the center 450 of the shaft 410 to the outer circumferential surface portion 413.

Accordingly, the rotation limiter 411 may be provided with at least one position having the same distance as the distance from the center 450 of the shaft 410 to the end portion 511 of the stopper 500. Accordingly, at the position, the end portion 511 of the stopper 500 may come into contact with the rotation limiter 411. At the position, the stopper 500 may interfere with the rotation limiter 411 and thus the rotational movement thereof may be limited.

That is, the distance from the center 450 of the shaft 410 to the end portion 511 may be within the range of the distance from the center 450 of the shaft 410 to the rotation limiter 411. Accordingly, in at least one portion, the rotation limiter 411 may have the same distance as the end portion 511.

The stopper 500 may include the contact surface 512. The contact surface 512 may be formed to extend from the end portion 511. The contact surface 512 may be provided in a shape corresponding to the surface of the rotation limiter 411. For example, the contact surface 512 and the surface of the rotation limiter 411 may be provided as a flat surface or a curved surface.

Accordingly, the stopper 500 may come into surface contact with the rotation limiter 411 through the contact surface 512 when the stopper 500 interferes with the rotation limiter 411. Depending on the shape of the rotation limiter 411 and the contact surface 512, when the stopper 500 and the rotation limiter 411 interfere with each other, the surface contact between the rotation limiter 411 and the contact surface 512 may occur simultaneously with the contact between the rotation limiter 411 and the end portion 511, or may occur sequentially after the contact between the rotation limiter 411 and the end portion 511.

Accordingly, when limiting the opening angle of the outer door 200, the interaction between the rotation limiter 411 of the hinge 400 and the stopper 500 may be more stable.

The contact surface 512 of the stopper 500 may extend in an inclined direction from the end portion 511. The shape of the rotation limiter 411 may be provided to correspond to the inclination of the contact surface 512 of the stopper 500. By adjusting the inclination of the rotation limiter 411 and the inclination of the contact surface 512 of the stopper 500, a limit angle when the outer door 200 is opened may be determined. At this time, the inclination may mean an inclination in the front and rear direction or the left and right direction.

The contact surface 512 of the stopper 500 may be extended so as to be inclined in a direction that is away from the center 450 of the shaft 410 when extending from the end portion 511.

Particularly, even under the same opening angle conditions of the outer door 200, the contact surface 512 of the stopper 500 and the rotation limiter 411 may have various inclinations. Depending on the inclination of the rotation limiter 411, a range of a region occupied by the outer circumferential surface portion 413 of the shaft 410 may vary in the shaft 410.

When the contact surface 512 is inclined from the end portion 511 in a direction away from the center 450 of the shaft 410, a region occupied by the outer circumferential surface portion 413 of the shaft 410 in the circumferential direction may increase. Accordingly, under the same opening angle condition of the outer door 200, a region occupied by the first outer circumferential surface 413a may increase, and a region occupied by the second outer circumferential surface 414a may decrease in the outer circumferential surface of the shaft 410. Accordingly, under the same opening angle condition of the outer door 200, the shaft 410 may become thicker. Under the same opening angle condition of the outer door 200, the durability of the hinge 400 may be increased.

Conversely, when the contact surface 512 is inclined from the end portion 511 in a direction that is relatively less away from the center 450 of the shaft 410, a region occupied by the outer circumferential surface portion 413 in the circumferential direction may be narrowed in the shaft 410. Accordingly, the shaft 410 may be relatively thinner under the same opening angle conditions of the outer door 200.

The stopper 500 may be provided in a shape in which the end portion 511 protrudes relatively toward the shaft 410. For example, the end portion 511 of the stopper 500 may be provided in a substantially pointed shape. One surface of the stopper 500 facing the shaft 410 may be provided with the contact surface 512 formed on one side and a recessed surface 513 formed on the other side based on the end portion 511.

The recessed surface 513 may extend from the end portion 511 to the other side. The recessed surface 513 may be provided to allow at least a portion thereof to be inclined in a direction away from the center 450 of the shaft 410.

A start point of the rotation guide portion 412 may be provided adjacent to the end portion 511 of the stopper 500 based on the position of the stopper 500 when the outer door 200 is closed. A point in which the rotation guide portion 412 and the outer circumferential surface portion 413 are connected may be formed at a position adjacent to the end portion 511 of the stopper 500 based on the position of the stopper 500 when the outer door 200 is closed.

When the stopper 500 is provided in a shape in which the end portion 511 protrudes because the stopper 500 includes the recessed surface 513, a region occupied by the outer circumferential surface portion 413 may be expanded in the shaft 410 compared to a case in which the stopper 500 does not include the recessed surface 513. Accordingly, the shaft 410 may become relatively thicker, and the durability of the hinge 400 may be increased.

The rotation limiter 411 may be formed integrally with the shaft 410. Accordingly, the hinge 400 may not require a process of separately manufacturing and welding the rotation limiter 411. Accordingly, the assembly process of the hinge 400 may be simplified. The durability of the hinge 400 may be increased.

For example, the hinge 400 may be formed integrally with the rotation limiter 411 through die-casting or the like, or the hinge 400 may form the rotation limiter 411 by cutting the cylindrical shaft 410.

Accordingly, thicknesses of the hinge 400 and the stopper 500 may be less than a case in which a separate rotation limiter 411 is welded or formed. Accordingly, thicknesses of the outer door 200 and the inner door 100 that are connected to each other by the hinge 400 and the stopper 500 may be reduced.

The stopper 500 may be arranged to be positioned on the plate 420 of the hinge 400 in a state in which the outer door 200 is closed. A rear end portion of the plate 420 may protrude upward. Accordingly, the stopper 500 may be coupled to the side surface of the shaft 410 to reinforce strength thereof without blocking the forward rotational movement.

The rotation limiter 411 and the stopper 500 may be provided inside the door 31. The rotation limiter 411 and the stopper 500 may be provided between the inner door 100 and the outer door 200.

The rotation limiter 411 and the stopper 500 may be positioned on an inner side than an outer surface of the door 31. That is, the rotation limiter 411 and the stopper 500 may be positioned closer to the center of the main body 10 than to a side boundary of the main body 10. Accordingly, interference with furniture, and the like, around the refrigerator 1 may be prevented, and space utilization may be improved.

The rotation limiter 411 of the hinge 400 may be formed on the shaft 410. Accordingly, an area of the rotation limiter 411 of the hinge 400 may be formed within an area of the shaft 410. Accordingly, the hinge 400 and the stopper 500 may include a material having high rigidity.

For example, the hinge 400, in which the rotation limiter 411 is formed, may include a die-cast metal material. The hinge 400 may include a die-cast material.

For example, the stopper 500 may include a steel material.

Accordingly, the hinge 400 and the stopper 500 of the present disclosure may implement a rotation limitation structure in a narrow area.

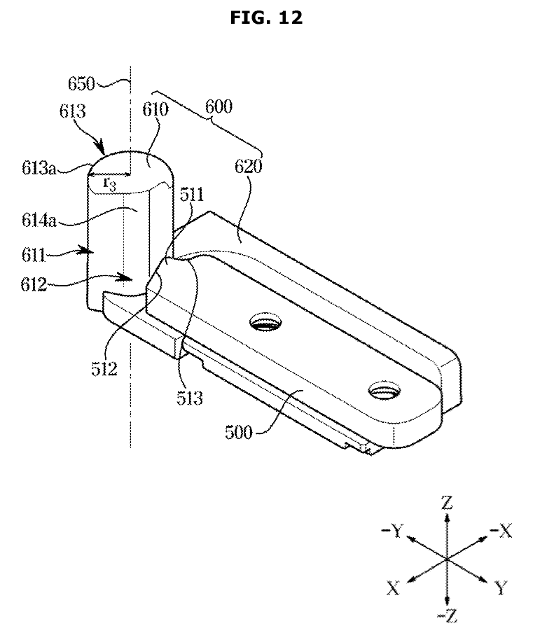

FIG. 12 is a perspective view of a hinge and a stopper according to one embodiment of the present disclosure.

In the following description, for convenience of description, configurations that are substantially the same or similar to those described with reference to FIGS. 8-11 may be omitted or briefly described.

Referring to FIG. 12, a hinge 600 according to one embodiment of the present disclosure may include a shaft 610 and a plate 620. The shaft 610 may be formed to protrude from the plate 620. The shaft 610 and the plate 620 may be integrated with each other.

The shaft 610 may be inserted into a lower insertion hole 282 (refer to FIG. 7) of a lower hinge receiving portion 281 (refer to FIG. 7) of an outer door 200.

The hinge 600 may be coupled to a first hinge mounting portion 131 (refer to FIG. 7) of an inner door 100. Particularly, the plate 620 of the hinge 600 may be coupled to an upper surface of the first hinge mounting portion 131 (refer to FIG. 7). The hinge 600 may be fixed to the inner door 100.

A stopper 500 may be coupled to the outer door 200. The stopper 500 may be coupled to a lower hinge receiving portion 271 (refer to FIG. 7) of the outer door 200. The stopper 500 may be rotationally moved together with the outer door 200.

The shaft 610 may include an outer circumferential surface portion 613, a rotation guide portion 612, and a rotation limiter 611.

The outer circumferential surface portion 613 may be provided in a region corresponding to a first outer circumferential surface 613a provided along a radius (r3) of the shaft 610. Accordingly, the outer circumferential surface portion 613 may be provided to have the constant radius (r3) from a center 650 of the shaft.

The radius (r3) the shaft 610 may be set to be greater than a radius (r1) (refer to FIG. 11) of a rotation shaft portion 410a (refer to FIG. 11).

The rotation guide portion 612 and the rotation limiter 611 may be provided in a region corresponding to a second outer circumferential surface 614a. A distance from the second outer circumferential surface 614a to the center 650 of the shaft may be less than the radius (r3) of the shaft. The second outer circumferential surface 614a may be provided on an inner side of the radius (r3) of the shaft.

The stopper 500 may be configured to rotationally move along the rotation guide portion 612. The stopper 500 may be arranged to be spaced apart from the rotation guide portion 612. An end portion 511 of the stopper 500 may be spaced apart from the rotation guide portion 612.

The stopper 500 may be provided to allow the end portion 511 to be positioned inside the radius (r3) of the shaft. The end portion 511 may be positioned inside the radius (r3) of the shaft.

A distance from the center 650 of the shaft to the rotation guide portion 612 may be set to be less than a distance from the center 650 of the shaft to the end portion 511. Accordingly, the end portion 511 may be spaced apart from the rotation guide portion 612.

The rotation limiter 611 may be provided between the rotation guide portion 612 and the outer circumferential surface portion 613. The rotation limiter 611 may be provided to connect the rotation guide portion 612 and the outer circumferential surface portion 613. The rotation limiter 611 may be provided to allow the rotation guide portion 612 and the outer circumferential surface portion 613 to be stepped from each other.

Accordingly, in at least a portion of the rotation limiter 611, a distance to the center 650 of the shaft may be the same as a distance to the end portion 511. That is, a distance from the shaft to the end portion 511 may be provided within a range of the distance from the shaft to the rotation limiter 611. Accordingly, the end portion 511 may come into contact with the rotation limiter 611. Accordingly, the end portion 511 and the rotation limiter 611 may interfere with each other.

The stopper 500 may include the end portion 511, a contact surface 512, and a recessed surface 513. The end portion 511 may be a portion of the stopper 500 that is closest to the center 650 of the shaft. The end portion 511, the contact surface 512, and the recessed surface 513 may all be provided on one surface of the stopper 500 facing the shaft. The end portion 511 may be provided between the contact surface 512 and the recessed surface 513.

The contact surface 512 and the recessed surface 513 may each be formed by extending from the end portion 511.

The contact surface 512 may be provided to be inclined. The contact surface 512 may be provided to be inclined in a direction away from the center 650 of the shaft.

At least a portion of the recessed surface 513 may be provided to be inclined. At least a portion of the recessed surface 513 may be provided to be inclined in a direction away from the center 650 of the shaft.

The contact surface 512 may be provided to correspond to the rotation limiter 611. The stopper 500 and the rotation limiter 611 may be in surface contact with each other.

Accordingly, an opening angle of the outer door 200 may be controlled. Accordingly, the rotation of the outer door 200 may be limited at a limit angle.

A refrigerator 1 according to the present disclosure may include a main body 10, in which a storage compartment is formed, the main body including an inner case 11 and an outer case 12, an inner door 100 configured to be rotatable in front of the main body 10 and including an opening 101, an outer door 200 configured to be rotatable in front of the inner door 100 so as to open and close the opening 101, a hinge 400 provided to allow the outer door 200 to be rotatably coupled thereto and including a shaft 410 provided with a rotation limiter 411 to limit an opening angle of the outer door 200, and a stopper 500 configured to rotationally move along a circumference of the shaft 410 and configured to limit an opening angle of the outer door 200 by being in contact with the rotation limiter 411 formed in the shaft 410.

The stopper 500 may be coupled to the outer door 200. The stopper 500 may be configured to rotationally move in a predetermined angular range along the circumference of the shaft 410. At an end position of the rotational movement, the stopper 500 may be configured to allow the rotation of the outer door 200 in an opening direction to be stopped by the rotation limiter 411.

The shaft 410 may further include an outer circumferential surface portion 413 including an outer circumferential surface 413a formed along a constant radius (r), and a rotation guide portion 412 formed in such a way that at least a portion of the shaft 410 retracts toward a center 450 of the shaft 410 to correspond to a rotational movement path of the stopper 500.

The rotation limiter 411 may extend from one end of the rotation guide portion 412 to the outer circumferential surface portion 413.

The stopper 500 may be spaced apart from the rotation guide portion 412.

The stopper 500 may include an end portion 511 provided on one side facing the shaft 410. A distance between the end portion 511 and the center 450 of the shaft may be less than a radius (r) of the shaft 410.

The stopper 500 may include a contact surface 512 extending from the end portion 511 and provided to be in surface contact with the rotation limiter 411.

The stopper 500 may be provided to allow the contact surface 512 to be inclined from the end portion 511 in a direction away from the center 450 of the shaft 410.

The hinge 400 may be provided on the inner door 100. The stopper 50 may be provided on the outer door 200 so as to rotationally move together with the outer door 200.

The hinge 400 may further include a plate 420 configured to be coupled to the inner door 100. The shaft 410 and the plate 420 may be formed integrally with each other.

The shaft 410 may include a rotation shaft portion 410a inserted into the outer door 200, and a reinforcing portion 410b positioned between the rotation shaft portion 410a and the plate 420. A radius of the reinforcing portion 410b may be greater than a radius of the rotation shaft portion 410a.

The rotation limiter 411 may be formed as a single flat surface on a portion of the rotation shaft portion 410a and a portion of the reinforcing portion 410b.

The rotation guide portion 412 may be formed as a single curved surface on a portion of the rotation shaft portion 410a and a portion of the reinforcing portion 410b.

The stopper 500 may be positioned on the plate 420 of the hinge 400 in response to the outer door 200 being closed.

The rotation limiter 411 may be formed by cutting a cylindrical shaft 410 or be formed integrally using a die.

A refrigerator 1 according to the present disclosure may include a main body 10, in which a storage compartment is formed, the main body including an inner case 11 and an outer case 12, a door configured to open and close the storage compartment and including an inner door 100 including an opening 101, an outer door 200 configured to open and close the opening 101, and a hinge 400 configured to allow the inner door 100 and the outer door 200 to rotate relative to each other and including a shaft 410. The shaft 410 may include a first circumferential surface 413a including a first radius (r) with respect to a circumferential direction, and a second circumferential surface 414a in which a distance from a center 450 of the shaft 410 is different from the first radius (r) and a rotation limiter 411 is provided.

The shaft 410 may include a rotation guide portion 412 provided on the second outer circumferential surface 414a and having a distance from the center 450 of the shaft 410 less than the first radius (r).

The first radius (r) may be set to be greater than a distance from the center 450 of the shaft 410 to the second outer circumferential surface 414a.

The rotation limiter 411 may be provided between the first outer circumferential surface 413a and the rotation guide portion 412.

The door may further include a stopper 500 provided to be in surface contact with the rotation limiter 411 at a maximum opening angle of the outer door 200 so as to limit opening angles of the inner door 100 and the outer door 200.

As is apparent from the above description, a hinge including a rotation limiter may be provided and thus an opening angle of an outer door may be controlled.

Further, a hinge may be formed by integrating a shaft and a plate, thereby improving durability and ease of manufacture.

Further, a rotation limiter of a shaft may be provided in an inner region of a radius of a shaft and thus it is possible to maintain a relatively small thickness of a door.

Additional aspects of the disclosure will be set forth in part in the description which follows and, in part, will be obvious from the description, or may be learned by practice of the disclosure.

While the present disclosure has been particularly described with reference to exemplary embodiments, it should be understood by those of skilled in the art that various changes in form and details may be made without departing from the spirit and scope of the present disclosure.

1. A refrigerator comprising:
a main body, in which a storage compartment is formed, the main body including an inner case and an outer case;
an inner door that is rotatable relative to the main body to open and close the storage compartment, the inner door including an opening;
an outer door in front of the inner door and that is rotatable relative to the inner door to open and close the opening;
a hinge to which the outer door is coupled, the hinge including:
a shaft that allows the outer door to rotate, and
a rotation limiter on the shaft that is configured to limit an opening angle of the outer door relative to the inner door; and
a stopper on the outer door and configured to:
with the outer door rotated relative to the inner door, move along a circumference of the shaft, and
with the stopper in contact with the rotation limiter, limit the opening angle of the outer door relative to the inner door.

2. The refrigerator of claim 1, wherein
the stopper is coupled to the outer door,
with the outer door rotated relative to the inner door, the stopper moves in a angular range along the circumference of the shaft, and
at an end position of the angular range, movement of the stopper is stopped by the rotation limiter such that rotation of the outer door relative to the inner door in an opening direction is stopped.

3. The refrigerator of claim 2, wherein
the shaft further includes:
an outer circumferential surface portion including an outer circumferential surface of the shaft extended along a first portion of the shaft and having a first radius that is a constant distance from a center of the shaft, and
a rotation guide portion including a rotation guide surface of the shaft extended along a second portion of the shaft having a second radius that is less than the first radius, the rotation guide portion configured such that, with the outer door rotated relative to the inner door, the rotation guide portion allows the stopper to move along a rotational movement path.

4. The refrigerator of claim 3, wherein the rotation limiter extends from an end of the rotation guide portion to and end of the outer circumferential surface portion.

5. The refrigerator of claim 3, wherein with the stopper spaced apart from the rotation limiter, the stopper is spaced apart from the rotation guide portion in a radial direction of the shaft.

6. The refrigerator of claim 5, wherein
the stopper includes an end portion on a side facing the shaft, and
a distance between the end portion and a center of the shaft is less than the first radius.

7. The refrigerator of claim 6, wherein
the stopper includes a contact surface that extends from the end portion to an edge of the stopper, and
with the stopper in contact with the rotation limiter, the contact surface is in surface contact with the rotation limiter.

8. The refrigerator of claim 7, wherein the contact surface is inclined from the end portion in a direction away from the center of the shaft.

9. The refrigerator of claim 2, wherein
the hinge is on the inner door and moves together with the inner door, and
the stopper moves together with the outer door.

10. The refrigerator of claim 3, wherein
the hinge further includes a plate coupled to the inner door, and
the shaft and the plate are formed integrally with each other.

11. The refrigerator of claim 10, wherein
the shaft includes:
a rotation shaft portion inserted into the outer door, and
a reinforcing portion between the rotation shaft portion and the plate, and
a radius of the shaft along the reinforcing portion is greater than a radius of the shaft along the rotation shaft portion.

12. The refrigerator of claim 11, wherein
the rotation limiter includes a flat surface that extends on a portion of the rotation shaft portion and on a portion of the reinforcing portion.

13. The refrigerator of claim 11, wherein
the rotation guide portion includes a curved surface that extends on a portion of the rotation shaft portion and on a portion of the reinforcing portion.

14. The refrigerator of claim 10, wherein
with the outer door rotated relative to the inner door to a closed position where the opening is closed by the outer door, the stopper is above the plate of the hinge.

15. The refrigerator of claim 1, wherein
the rotation limiter is cut into a cylindrical shaft, or
the hinge is shaped by a die to include the rotation limiter.
